(19) United States
(12) Patent Application Publication
(10) Pub. No.: US 2009/0245487 A1
(43) Pub. Date: Oct. 1, 2009

(54) Device for Alerting a Telephone Caller When a Live Person is Reached

(76) Inventor: William Jockusch, Cambridge, MA (US)

Correspondence Address: Russ Weinzimmer, 614 Nashua Street, Suite 53, Milford, NH, 03055, US

(21) Appl. No.: 12/058,713

(22) Filed: Mar. 30, 2008

(51) Int. Cl. H04M 11/00

(52) U.S. Cl. 379/93.01

(57) ABSTRACT

An apparatus and method of use are disclosed that monitor a telephone call and alert the caller when a live person is reached. The apparatus includes a computing device, a telephone interface, live person detecting software, and a caller alert system. Preferred embodiments include a digitizer, and some embodiments transmit a zero tone to the destination. Strategies for live person detection can include: detecting a short period of sound followed by a sustained pause, analyzing the talking speed and/or speed variability of detected speech, recognizing one or more words typical of a live person, and providing a verbal prompt and detecting an expected reply. In some embodiments strategies and/or prompts are selectable. Caller alert systems include bells, buzzers, lights, speakers, and/or vibrators, as well as ringing the telephone itself. Some embodiments include a timer and terminate a call if too much time elapses and a live person is not reached.

### FIELD OF THE INVENTION

The invention generally relates to telephony, and more specifically to devices for automating the placement of telephone calls.

### BACKGROUND OF THE INVENTION

When calling a company or other organization, it is not uncommon to be placed initially on hold until someone is available to take the call, and many companies and organizations require a caller to interact initially with an automated “Interactive Voice Response” device, or IVR, before a live human being can finally be reached. Often, the caller is presented with unsolicited information, unwanted choices, and undesired advertisements, encouraged to listen to recorded answers to frequently asked questions, and then placed on hold for an indefinite period of time before a live person finally comes on the line. And then, to make matters even worse, when a live person is finally reached the caller is often asked to provide for a second time most or all of the information that has already been provided to the IVR.

Being placed on hold is never advantageous to a caller, and while IVR systems may offer advantages to callers in some circumstances, they are highly frustrating and waste significant amounts of a caller's time when the caller knows that his or her needs cannot be met by a recorded message, and that communication with a live person is needed. As a result, caller time can be wasted, callers can become frustrated, and, depending on the configuration of the telephone, callers can be forced to suspend their normal activities for an indefinite amount of time and “hang on the phone” while waiting for a live person to finally take the call.

Some IVR systems allows a caller to press zero to reach a live person, and if no “touch-tone” input is received many IVR systems will eventually assume that the call is a “pulse-dialed” call instead of a touch-tone call and will route the call to a live person. However, even under these circumstances the caller is often placed on “hold” until a live person is available.

Solutions have been proposed that would provide a visual map of an IVR system, thereby allowing a caller to select a desired destination from the map and avoid the much slower process of navigating through the options presented by the IVR. However, these solutions require that the organization using the IVR system provide a visual map and that the caller be equipped with hardware and software that is compatible with the provided map. And these solutions do not address the problem of caller time being wasted while on hold.

### SUMMARY OF THE INVENTION

An apparatus and method of use thereof are disclosed that minimize caller frustration and wasting of a caller's time while waiting for a call to reach a live person. The apparatus includes a computing device and a telephone interface that is at least connectable to a telephone so as to detect telephone signals originating from a call destination and provide them to the computing device. The apparatus further includes software that is operational on the computing device and can automatically detect when a live person has been reached at the call destination, as well as a caller alert system that is able to alert the caller when a live person has been reached.

In preferred embodiments, the apparatus further comprising a telephone handset that is able to place a manually initiated telephone call. In various preferred embodiments, the software uses one or more of the following strategies to determine if a live person has been reached: detecting a short period of sound followed by a sustained pause (such as a person saying “hello” and waiting for a reply), comparing detected speech with the speed and/or speed variability that is typical of a live person, using speech recognition software to recognize one or more words that are typical of a live person (such as “hello” or “can I help you”), and using a speech synthesizer to provide a verbal prompt (such as “are you a real person” or “press one of you are a real person”) and detecting an expected reply (such as the word “yes” or a touch-tone “1”). In some of these preferred embodiments the caller is able to select or specify which strategies will be used, and/or specify or select a prompt and/or an expected reply used in a strategy.

In preferred embodiments, the apparatus transmits one or more touch-tones and or one or more synthesized words to the call destination, such as the touch-tone digit zero or the word “agent,” in an attempt to expedite reaching a live person.

In various preferred embodiments, when a live person is detected the apparatus alerts the caller by activating a bell, a buzzer, a light, a sound emitting device that is able to emit at least one audible tone, and/or a vibrating device that is able to generate vibrations that can be felt by the caller. In other preferred embodiments the apparatus alerts the caller by causing the call originating telephone handset to ring and/or vibrate.

In some preferred embodiments the apparatus includes a timer that measures the elapsed time while waiting to reach a live person, and allows the apparatus to terminate the call if a predetermined maximum elapsed time is exceeded and a live person has not been reached.

In other preferred embodiments the apparatus includes a touch tone generator and/or a speech synthesizer and is able to send a prompt to the call destination that includes at least one touch tone signal or speech synthesized word, the prompt being derived from an information source that is either locally or remotely stored. And in some of these preferred embodiments the apparatus is able to react to the success or failure of a prompt by recording information to an information source, adding prompts to and/or deleting prompts from an information source, and editing prompt information in an information source

The method of the invention includes providing an apparatus as described above, connecting it to a telephone system, placing a call, and activating the device. The device then monitors sound coming from the call destination and automatically detects if a live person has been reached. Upon detection of a live person, the apparatus alerts the user so that the user can pick up the call.

### BRIEF DESCRIPTION OF THE DRAWINGS

FIG. 1A is a functional diagram that illustrates the elements of a preferred embodiment of the present invention wherein the telephone interface is connected between the telephone handset and the call destination;

FIG. 1B is a functional diagram that illustrates the elements of a preferred embodiment of the present invention wherein the telephone interface is connected between a telephone handset base station and a wired telephone ear and mouth piece;

FIG. 1C is a functional diagram that illustrates the elements of a preferred embodiment of the present invention wherein the computing device is a computer that includes telephone functionality using a network interface card included in the computer that receives voice-over-IP telephony signals;

FIG. 2 is a functional diagram that illustrates the strategy for detecting a live person in a preferred embodiment; and

FIG. 3 is a functional diagram illustrating a preferred embodiment of the method of the invention.

### DETAILED DESCRIPTION OF PREFERRED EMBODIMENTS

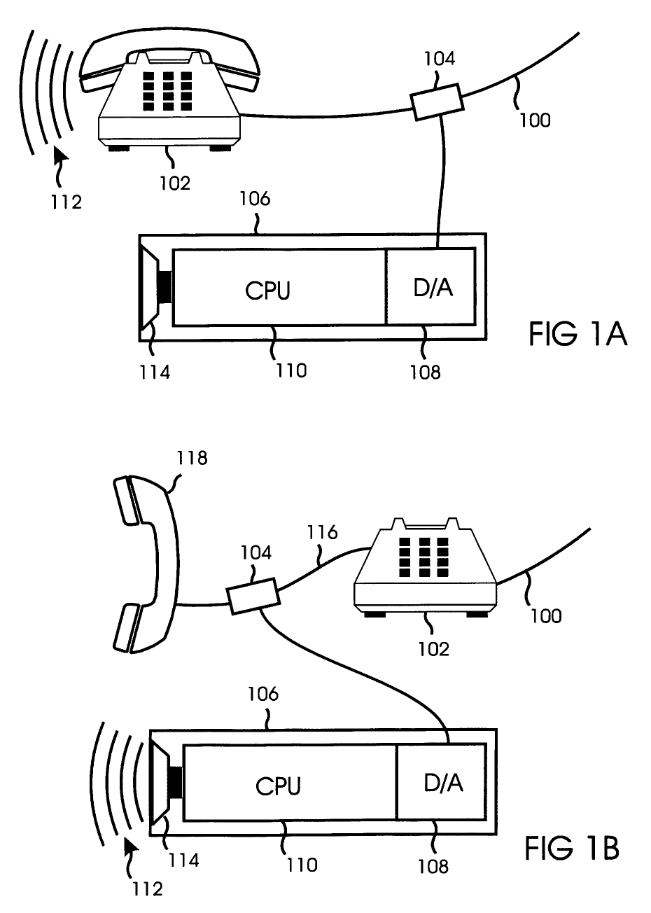

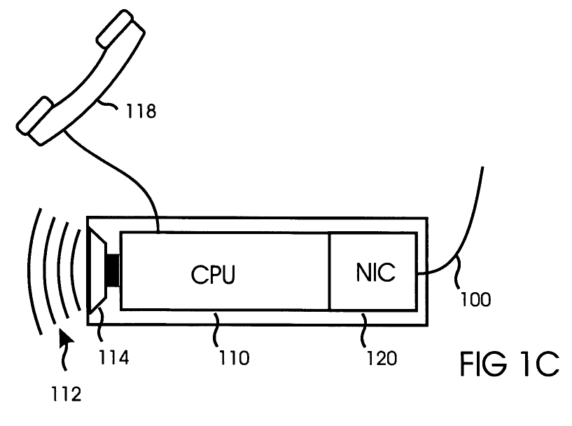

With reference to FIG. 1A, in a preferred embodiment a telephone cable 100 connecting a telephone handset 102 to a call destination is interrupted by a telephone interface 104, which can be a splitter, a switch, or another, similar device. In preferred embodiments where the telephone interface 104 is a switch, the telephone cable 100 is disconnected from the handset 102 when the apparatus of the invention is activated. The telephone interface 104 supplies telephony signals to a computer 106. In the embodiment of FIG. 1A, the computer includes a digitizer 108 that can digitize analog input and convert it into digital output appropriate for further analysis by the computer CPU 110. In similar embodiments, a digitizer 108 is contained in a separate housing or in the telephone interface and is connected to the computer 106 by a cable.

Software running on the computer 106 analyzes the telephony signals received from the telephone cable 100, and uses one or more strategies as discussed below to determine if a live person has been reached. When a live person is detected, the computer 106 sends a signal through the telephone interface 104 that causes the telephone to ring 112, thereby alerting the caller that a live person has been reached. When the caller activates the handset 102, the telephone reconnects the call to the handset 102. In similar embodiments, instead of causing the handset to ring 112, the computer 106 causes a sound to be emitted from a speaker 114, a bell to ring, a light to turn on, and/or uses other means to alert the user.

In embodiments using wireless telephones, the cable 100 and telephone interface 104 shown in FIG. 1A are replace by wireless communications. In some of these embodiments, the computer 106 or other computing device is located at a remote location, such as the premises of a cellular telephone service provider, and the functionality of the present invention is provided to cellular callers as an added service of the cellular telephony provider.

FIG. 1B illustrates a preferred embodiment similar to the embodiment of FIG. 1A, except that the telephone interface 104 interrupts a cable 116 that connects the telephone handset 102 to a wired ear and mouth piece 118. An advantage of this embodiment as compared to the embodiment of FIG. 1A is that it is independent of the type of telephone system used, thereby allowing identical apparatus to work with a handset connected to an analog POTS (“plain old telephone service) system, as is normally used in a home, a handset connected to a digital telephony system, as is typically used in an office environment, or a voice-over-IP (VoIP) handset that receives telephony transmitted over the internet. Disadvantages of this embodiment as compared to the embodiment of FIG. 1A are that it requires a handset 102 with a wired ear and mouth piece 116 and it cannot cause the handset 102 to ring when a live person is reached. However, these disadvantages are overcome in similar embodiments that include the telephone as part of the apparatus, and thereby are able to replace the wired connections 104, 116 of FIG. 1B with wireless connections, and are also able to ring the telephone as a means for alerting the caller when a live person has been reached.

FIG. 1C illustrates a preferred embodiment similar to the embodiments of FIG. 1A, and FIG. 1B, except that the computer 106 functions as a “voice-over-IP” or VoIP telephone that receives telephone calls over the internet. In this embodiment the telephone cable 100 is an internet cable that connects to a “network interface card” or NIC 120 included in the computer 106. Depending on the configuration of the apparatus, the call can be delivered to the user through a handset 116 (or headset) connected to the computer 106, or the computer 106 can function as a “speaker-phone.” When the apparatus is activated, the call is effectively disconnected from the user, and when a live person is reached the user can be alerted simply by hearing that the call has been reconnected to the handset or speaker.

In some preferred embodiments, the elements of the present invention are incorporated into either a conventional telephone apparatus or a cellular telephone handset, with the connectivity shown in FIG. 1A, FIG. 1B or FIG. 1C included within the combined apparatus.

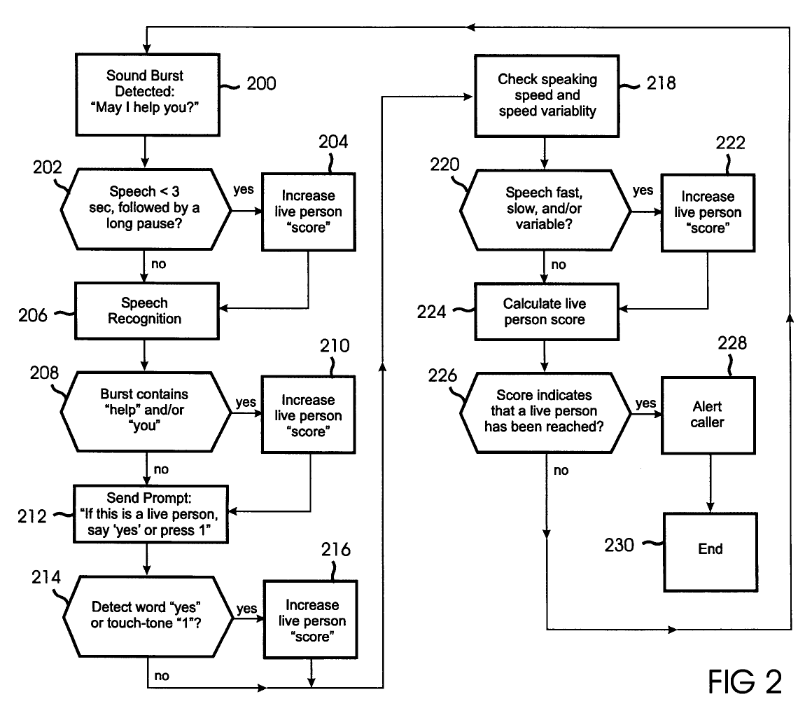

FIG. 2 is a functional diagram that illustrates the strategy used by the live person detecting software in a preferred embodiment to automatically determine if a live person has been reached. When sound originating from the call destination is detected 200, a series of criteria are applied to determine the likelihood that the sound originated from a live person. A “score” is assigned according to how well the sound satisfies each of the criteria, and the total score is used to determine if a live person has been reached. In this embodiment, the first criterion 202 is whether or not a short burst of sound (less than three seconds in this embodiment) is followed by a sustained pause. For example, a live person might be expected to say “hello” or “Hello, my name is Judy. How can I help you?” and then wait for a response. If the sound burst satisfies this criterion, the live person score is increased 204.

As the next step, speech recognition is applied 206 and the sound is analyzed 208 to determine if any of several “live person typical words” are detected 208, such as “help” or “you.” Once again, if the sound burst satisfies this criterion, the live person score is increased 210.

In the next step 212, a synthesized speech prompt is sent to the call destination, such as “if this live person, say ‘yes’ or press 1.” The system then waits for an audible response from the call destination and analyzes the response 214 to determine if an expected response (such as “yes” or a touch-tone numeral 1) is received. If so, then the live person score is increased 216.

As the next step in recognizing a live person, the average speed at which words are spoken and the degree of variability of the speed are analyzed 218. Synthesized speech and speech recorded for use by an IVR is typically slower and more even in speed, as compared to live speech. Hence, if rapid speech and/or speech that is highly variable in speed is detected 220, the live person score is increased 222.

After all of these criteria have been applied to a burst of speech received from the call destination, the total live person score is calculated 224, and if the total score indicates that a live person has been reached 226 the caller is alerted 228 and the detection activity terminates 230. If the score does not indicate that a live person has been reached, the software waits for another burst of sound and repeats the analysis. In similar embodiments, some of the criteria shown in FIG. 2 are omitted and/or other criteria are included.

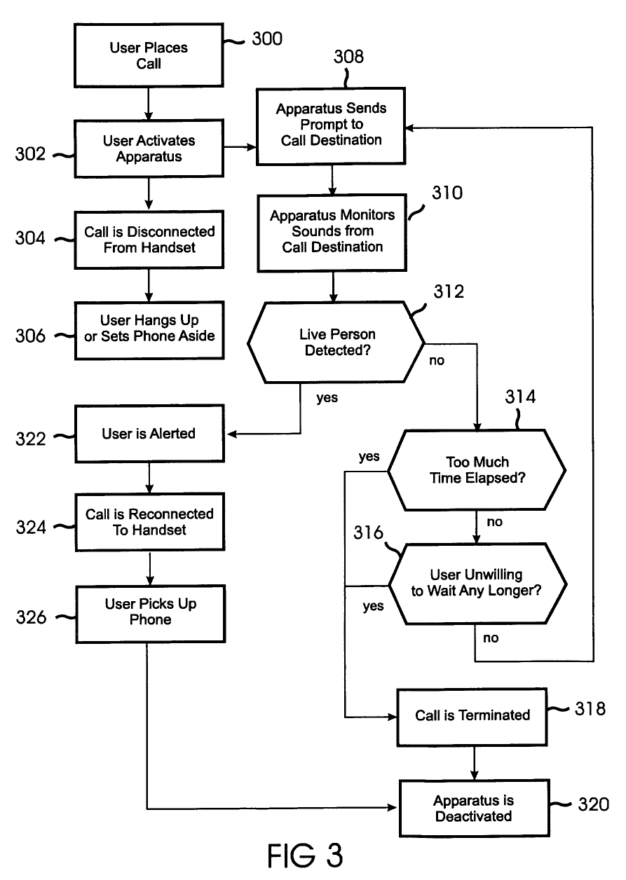

With reference to FIG. 3, in a preferred embodiment of the method of the invention a caller places a call 300 and then activates the apparatus of the invention 302, which has been previously obtained and connected to the telephone system. The call is then disconnected from the handset 304 and the caller either hangs up the phone or sets it aside 306, while the apparatus sends a prompt to the call destination 308 and then monitors sound originating from the call destination 310 to determine if a live person has been detected 312.

In some embodiments the prompt sent to the call destination 308 is the touch tone numeral zero. In others it is a string of random touch tone characters and/or speech synthesized spoken words, and in still others it is a series of touch tone signals and/or words that is known to have succeeded in the past at reaching a live person, either through direct experience or due to information retrieved from a list posted on the internet such as www.gethuman.com or from some other information source. In some of these latter embodiments, if the prompt is successful in reaching a live person, this information is recorded and/or transmitted over the internet to an information source so that a rating or “score” can be compiled as to the degree of success of each known prompt. In some of these preferred embodiments, the prompt that can be used to reach a live person is voluntarily supplied by an IVR owner or vendor, or by another information source related to the IVR. In cases where the prompt is provided by an information source related to the IVR, and when tried the prompt does not provide access to a live person, this information can be recorded and/or transmitted to an information source so that the incorrectly functioning prompt is no longer used.

If a live person is not detected, the apparatus determines if too much time has elapsed 314 or if the user is no longer willing to wait for a live person 316. If either of these conditions is true, the apparatus ends the call 318 and deactivates itself 320. On the other hand, if too much time has not elapsed, and if the user is willing to wait longer, the apparatus continues to send prompts 308 to the call destination monitor sound 310 originating from the call destination. When a live caller is detected, the user is alerted 322, the call is reconnected to the handset 324, the user picks up the call 326, and the apparatus deactivates itself 318.

In some preferred embodiments, if the apparatus incorrectly identifies sound as coming from a live person the user can press a button or otherwise alert the system of the failure, thereby allowing internal software to adjust live person detection parameters and/or causing information regarding the detection error to be sent over the internet to design and support personnel so that improvements can be made to the detection algorithms.

Other modifications and implementations will occur to those skilled in the art without departing from the spirit and the scope of the invention as claimed. Accordingly, the above description is not intended to limit the invention except as indicated in the following claims.

What is claimed is:

1. An apparatus for automatically alerting a caller when a live person has been reached during a telephone call, the apparatus comprising:
a computing device;
a telephone interface that is at least connectable to a telephone system and is able to detect telephone signals originating from a call destination and provide them to the computing device;
live person detecting software that is operational on the computing device and able to automatically detect when a live person has been reached at the call destination; and
a caller alert system that is able to alert a caller when a live person has been reached at the call destination.

2. The apparatus of claim 1, further comprising a telephone handset device that is able to place a manually initiated telephone call.

3. The apparatus of claim 1, wherein the live person detecting software interprets reception of a short period of sound followed by a sustained pause as evidence that a live person has been reached.

4. The apparatus of claim 1, wherein the live person detecting software includes speech recognition software.

5. The apparatus of claim 4, wherein the live person detecting software includes a live person typical word library containing at least one live person typical word, and wherein the live person detecting software interprets detection of at least one live person typical word as evidence that a live person has been reached.

6. The apparatus of claim 1, further comprising a speech synthesizer controllable by the live person detecting software and capable of generating synthetic speech that can be transmitted to the call destination.

7. The apparatus of claim 6, wherein the apparatus transmits at least one word of synthesized speech to the call destination in an attempt to expedite reaching of a live person.

8. The apparatus of claim 6, wherein the live person detection software is able to use the speech synthesizer to transmit a verbal prompt to the call destination, detect and recognize a reply to the verbal prompt, and interpret an expected reply to the verbal prompt as evidence that a live person has been reached.

9. The apparatus of claim 8, wherein the expected reply includes at least one touch-tone signal.

10. The apparatus of claim 8, wherein the apparatus further comprises speech recognition software and the expected reply includes at least one spoken word.

11. The apparatus of claim 8, wherein the caller is able to at least one of select and specify at least one of the verbal prompt and at least one expected reply associated with the verbal prompt.

12. The apparatus of claim 1, wherein the caller is able to select at least one strategy to be used by the live person detection software to determine if a live person has been reached.

13. The apparatus of claim 1, wherein the live person detection software further comprises speech recognition software and the live person detection software interprets detection of speech with at least one of an average speed within a certain range of speeds and a speed variability of a certain degree of variability as evidence that a live person has been reached.

14. The apparatus of claim 1, wherein the apparatus further comprises a touch-tone generator that is controllable by the computing device and is able to transmit touch-tone signals to the call destination.

15. The apparatus of claim 14, wherein the apparatus transmits at least one touch-tone signal to the call destination in an attempt to expedite reaching of a live person.

16. The apparatus of claim 1, wherein the caller alert system is able to alert the caller by at least one of:
ringing a bell;
activating a buzzer;
turning on a light;
causing a sound emitting device to emit at least one audible sound;
causing a vibrating device to generate vibrations that can be felt by the caller;
causing a telephone to ring;
causing a telephone to vibrate;
causing sound generated at the call destination to become audible to the caller;
displaying a visual indication on a computer screen; and
displaying a pop-up window on a computer screen.

17. The apparatus of claim 1, further comprising a call timer that measures the elapsed time while waiting to reach a live person and allows the apparatus to terminate the call if a predetermined maximum elapsed time has been exceeded and a live person has not been reached.

18. The apparatus of claim 1, further comprising at least one of a touch tone generator and a speech synthesizer, wherein the apparatus is able to send a prompt to the call destination, the prompt including at least one of a touch tone signal and a speech synthesized word, the prompt being at least one of derived from an information source and recorded with information regarding its success of use to an information source.

19. The apparatus of claim 18, wherein prompts are obtained from a list of prompts that are applicable to specific call destinations, the list of prompts being one of locally stored and remotely stored.

20. The apparatus of claim 19, wherein the apparatus is able to at least one of add prompts to the list of prompts, delete prompts from the list of prompts, edit information included in the list of prompts, and record information relating to at least one of successful and unsuccessful use of prompts in the list of prompts.

21. The apparatus of claim 1, wherein when the live person detection software falsely detects that a live person has been reached the apparatus is able to at least one of modify parameters in the live person detection software and convey information to at least one of design and support personnel regarding the false detection.

22. A method for automatically alerting a caller when a live person has been reached during a telephone call, the method comprising:
providing a device for automatically alerting a caller when a live person has been reached during a telephone call, the device comprising a computing device, a telephone interface, connectable to a telephone system and able to detect telephone signals originating from a call destination and provide them to the computing device, live person detecting software, operational on the computing device and able to automatically detect when a live person has been reached at the call destination, and a caller alert system that is able to alert a caller when a live person has been reached at the call destination;
connecting of the device to a telephone system;
originating of a call by the caller to a call destination;
activating of the device by the caller;
monitoring by the device of sounds received from the call destination so as to determine if a live person has been reached;
upon detection of a live caller by the device, alerting of the caller by the device that a live person has been reached.
